(19) United States
(12) Patent Application Publication
(10) Pub. No.: US 2004/0018280 A1
(43) Pub. Date: Jan. 29, 2004

(54) Preservation of muscle protein products

(76) Inventors: Herbert O. Hultin, Rockport, MA (US); Ingrid Undeland, Goteborg (SE); Mark P. Richards, Madison, WI (US)

Correspondence Address: FISH & RICHARDSON PC, 225 FRANKLIN ST, BOSTON, MA, 02110, US

(21) Appl. No.: 10/428,999

(22) Filed: May 2, 2003

Related U.S. Application Data
(60) Provisional application No. 60/377,624, filed on May 3, 2002.

(51) Int. Cl. A23L 1/27; A23B 4/00

(52) U.S. Cl. 426/264

(57) ABSTRACT

The invention relates to methods and compositions for preserving muscle tissue, by adding muscle tissue extracts to the muscle tissue.

### CROSS-REFERENCE TO RELATED APPLICATIONS

This application claims priority to U.S. Provisional Application No. 60/377,624 filed May 3, 2002, the contents of which is incorporated herein by reference in its entirety.

### STATEMENT AS TO FEDERALLY SPONSORED RESEARCH

This invention was made with Government support under U.S. Department of Agriculture, National Research Initiative Competitive Grant Program, Grant No. 97-35503-4531, and U.S. Department of Commerce, NOAA MIT Sea Grant, Grant No. 5700000741. The Government has certain rights in this invention.

### TECHNICAL FIELD

This invention relates to the preservation of muscle protein products.

### BACKGROUND

Rancidity development resulting from lipid oxidation often limits the shelf life of muscle tissue, e.g., pelagic fish proteins, during cold storage. In the case of fish, rancidity is characterized in part by unpleasant odors, e.g., stale, fishy, and/or “painty” odors. Many traditional anti-oxidative strategies for muscle foods are focused on preventing lipid auto-oxidation, e.g., as it occurs in bulk oils. Examples of these strategies are the use of synthetic radical scavengers, such as butylated hydroxyanisole (BHA), butylated hydroxytoluene (BHT), and tert-butylhydroquinone (TBHQ); employing oxygen exclusion, and storage in darkness and/or at sub-zero temperatures.

However, these strategies are often regarded as too expensive to use on low value muscle protein, e.g., from pelagic fish, and often fit poorly with demands by modem consumers for chilled, visually attractive, “all-natural,” and low fat products.

### SUMMARY

The present invention is based, in part, on the discovery that extracts of muscle tissue can inhibit lipid oxidation of muscle protein products, even when applied to products made from muscle tissue other than the source of the extract. The lipid oxidation that is inhibited by the new methods is generally catalyzed by heme, e.g., by hemoglobin and/or myoglobin.

In general, the invention features a method for preserving animal muscle by (a) obtaining a muscle tissue extract; and (b) adding the muscle tissue extract to muscle tissue in an amount sufficient to prevent lipid oxidation in the muscle tissue. The muscle tissue extract can be obtained by washing animal muscle with an aqueous solution or by pressing the animal muscle (e.g., using a French press or centrifugation), or both. The animal muscle tissue can include muscle tissue from white fish, such as cod, haddock, American dab, or flounder; fatty fish, such as herring, mackerel, bluefish, and menhaden; from krill; from shell fish such as shrimp and crabs; from poultry, such as chicken or turkey; or from beef, lamb, or pork, or any combination thereof.

The extract contains one or more components that have a weight of less than about 5,000 daltons, e.g., less than 4,000, 3,000, 2,000, 1,500, 1,000, or 500 daltons. The components are also heat stable up to at least 80° C. or 90° C., and even over 100° C., 110° C., or 120° C., and dialyzable.

In another aspect, the invention features a method for preserving animal muscle by inhibiting lipid oxidation in muscle tissue by (a) making a muscle tissue extract by a method that includes obtaining a first muscle tissue, and washing the first muscle tissue with an aqueous solution to form a muscle tissue extract; and (b) adding the muscle tissue extract to a second muscle tissue in an amount sufficient to prevent lipid oxidation in the second muscle tissue. The first and second muscle tissue can be from the same or a different type of animal (or can be from the same animal), and can be fish, poultry, or any mammalian muscle tissue.

In yet another aspect, the invention features a method for preserving animal muscle by inhibiting lipid oxidation in muscle tissue by (a) making a muscle tissue extract by a method that includes providing a first muscle tissue, and pressing the first muscle tissue to form a muscle tissue extract, and (b) adding the muscle tissue extract to a second muscle tissue in an amount sufficient to prevent lipid oxidation in the second muscle tissue. Again, the first and second muscle tissues can be from the same or a different type of animal. For example, the first muscle tissue can include fish, krill, and/or shrimp, and the second muscle tissue can be a high value food fish, such as cod, flounder, or haddock. Other combinations are possible.

Unless otherwise defined, all technical and scientific terms used herein have the same meaning as commonly understood by one of ordinary skill in the art to which this invention belongs. Although suitable methods and materials for the practice or testing of the present invention are described below, other methods and materials similar or equivalent to those described herein, which are well known in the art, can also be used. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

FIG. 1 is a line graph illustrating the temperature change in 20 mL press juice when heated in a boiling water bath for 10 minutes.

FIG. 2A is a line graph illustrating the storage-induced development of painty odor in whole minced cod muscle (♦), washed minced cod muscle with added cod press juice (▴), and washed minced cod muscle with added double distilled water (DDW; control) (x).

FIG. 2B is a line graph illustrating the storage-induced development of peroxide value (PV) in whole minced cod muscle (♦), washed minced cod muscle with added cod press juice (▴), and washed minced cod muscle with added DDW (control) (x).

FIG. 3A is a line graph illustrating the storage-induced development of painty odor in washed minced cod muscle with added 50 mM phosphate buffer (control) (*), crude cod press juice (▴), heated cod press juice (Δ), crude chicken press juice (♦), and heated chicken press juice (⋄).

FIG. 3B is a line graph illustrating the storage-induced development of PV in washed minced cod muscle with added 50 mM phosphate buffer (control) (*), crude cod press juice (▴), heated cod press juice (Δ), crude chicken press juice (♦), and heated chicken press juice (⋄).

FIG. 4 is a representation of a polyacrylamide gel (SDS-PAGE) (10-20%, linear gradient) that illustrates the sizes of the proteins in cod press juice before/after heating and fractionation. Lane 1: wide range molecular weight standards; Lane 2: cod press juice; Lane 3: heated cod press juice; Lane 4: <30 kDa fraction of cod press juice; Lane 5, <1 kDa fraction of cod press juice; Lane 6: cod press juice dialysis retentate; Lane 7: chicken press juice; Lane 8: heated chicken press juice; and Lane 9: high molecular weight standards. Protein was applied to all lanes at 7 μg/lane.

FIG. 5A is a line graph illustrating the storage-induced development of painty odor in washed minced cod muscle with added 50 mM phosphate buffer (control) (*), crude cod press juice stored 48 hours at 4° C. (□), crude cod press juice dialyzed for 48 hours against 50 mM phosphate buffer (pH 7) (3.5 kDa MW-cut off) (▪), heated cod press juice stored 48 hours at 4° C. (⋄), and heated cod press juice dialyzed for 48 hours against 50 mM phosphate buffer (pH 7) (3.5 kDa MW-cut off) (♦).

FIG. 5B is a line graph illustrating the storage-induced development of PV in washed minced cod muscle with added 50 mM phosphate buffer (control) (*), crude cod press juice stored 48 hours at 4° C. (□), crude cod press juice dialyzed for 48 hours against 50 mM phosphate buffer (pH 7) (3.5 kDa Mw-cut off) (▪), heated cod press juice stored 48 hours at 4° C. (⋄), and heated cod press juice dialyzed for 48 hours against 50 mM phosphate buffer (pH 7) (3.5 kDa Mw-cut off) (♦).

FIG. 6A is a line graph illustrating the storage-induced development of painty odor in washed minced cod muscle with added 50 mM phosphate buffer (control) (*), crude cod press juice (▴), <1 kDa fraction of cod press juice (▪), <30 kDa fraction of cod press juice (♦), <30 kDa fraction of dialyzed cod press juice (⋄), heated cod press juice (Δ) and <1 kDa fraction of heated cod press juice (□).

FIG. 6B is a line graph illustrating the storage-induced development of PV in washed minced cod muscle with added 50 mM phosphate buffer (control) (*), crude cod press juice (▴), <1 kDa fraction of cod press juice (▪), <30 kDa fraction of cod press juice (♦), <30 kDa fraction of dialyzed cod press juice (⋄), heated cod press juice (Δ), and <1 kDa fraction of heated cod press juice (□).

### DETAILED DESCRIPTION

The present invention relates to the use of muscle tissue extracts (one embodiment thereof is referred to herein as “press juice”) to preserve muscle proteins. The muscle tissue extracts exhibit antioxidative properties, e.g., an ability to inhibit hemoglobin (Hb)-catalyzed membrane lipid oxidation, in muscle proteins. The process of isolating aqueous muscle tissue extracts is simple and relatively inexpensive. The extracts can be prepared using any type of muscle tissue including those considered undesirable as a source of food for human consumption, e.g., low value animal muscle (e.g., fatty pelagic fish or fish by-products, mechanically deboned chicken, e.g., dark meat). Because the active components of the extract are of low molecular weight (e.g., less than 5,000 daltons, e.g., less than 4,000, 3,000, 2,000, 1,500, 1,000, or 500 daltons) and heat stable (e.g., stable at temperatures of about 100° C., e.g., up to 100, 90, 80, or even up to 110 or 120° C.), a substantially protein-free antioxidant concentrate/powder can be prepared from the liquid extracts.

1. Muscle Tissue

Muscle tissue extracts can be obtained from a variety of animal muscle tissues. Representative suitable sources of animal muscle from which muscle tissue extracts can be prepared include fish, e.g., white fish such as cod, flounder, trout, dab, and haddock, and fatty fish such as mackerel, menhaden, bluefish, and herring; krill; shellfish, such as shrimp; fowl, e.g., chicken; and mammals, e.g., beef, pork, and lamb. Further, it is contemplated that extracts can be obtained from mixtures of at least two sources of animal protein, e.g., fish and chicken, that have been ground/shredded and mixed together. Alternatively or in addition, extracts can be obtained from two or more sources of animal muscle tissue and combined to provide a mixture of extracts for use in the present invention.

The muscle tissue can be of any quality, ranging from fit/desirable for animal/human consumption to unfit/undesirable for animal/human consumption. In the case of fish, for example, any “high value” meat, e.g., a fillet, that is recovered from the fish can be utilized, as can any portion of the fish left after the fillets have been removed, e.g., heads and frames. As another example, in the case of chicken, breast, wing, and/or thigh meat can be utilized, as can any muscle protein-containing portion of the chicken remaining after high value portions have been removed. Similarly, animals that are often considered an undesirable source of food for human consumption can be utilized, e.g., fatty pelagic fish. Extracts can also be obtained from underutilized muscle sources, e.g., Antarctic krill, which is available in large quantities but is difficult to convert to human food because of its small size.

II. Muscle Tissue Extracts and Preparation

The term “muscle tissue extract,” as used herein, refers to a liquid that is or has been in contact with animal muscle tissue, or a solid or semi-solid residue obtained from such liquid, e.g., a powder prepared from such a liquid by complete or partial desiccation. The term includes liquid that has been exogenously added to muscle tissue, liquid that is endogenous to the muscle tissue, and mixtures thereof.

Muscle tissue extracts contain water-soluble components that inhibit oxidation of compounds, e.g., lipids, increasing the length of time (the “lag phase”) before which certain characteristics indicative of rancidity (e.g., “painty odors,” and/or peroxide value (PV)) become evident in muscle proteins. While not intending to be bound by theory, it is believed that the muscle tissue extracts prevent heme-catalyzed (e.g., hemoglobin catalyzed) lipid oxidation in the muscle tissue. The use of muscle tissue extracts can increase the lag phase, for example, by at least about 1 day, e.g., at least about 2 days, at least about 5 days, at least about 7 days, and in some cases, greater than 7 days. The components have molecular weights of less than about 5,000 daltons, e.g., about 4,500, 4,000, 3,500, 3,000, 2,500, 2,000, 1,500, 1,000, 500, 400, 250, 168, or 100 daltons. The components are also not deactivated by heating, and are heat stable at 80° C. and 90° C., up to about 100° C. or higher, even up to 110° C. and 120° C., e.g., 121° C.

Each of these muscle tissues described herein provide a muscle tissue extract that contains a certain amount of the heat-stable active components that have a molecular weight under 5000 daltons, but apparently some types of muscle tissues have a higher percentage of these active components. For example, white fish muscle appears to have the highest content of these active components, and thus provides the most effective or concentrated extract. It is believed that two of these active components are uric acid and glutathione.

Muscle tissue extracts can be made by any methods known in the art for adding liquids to and/or removing liquids from animal muscle tissue. In the case of exogenously-added liquids, any aqueous solution can be utilized to prepare the muscle tissue extracts. Particularly useful liquids are, for example, water, e.g., distilled water, salt solutions, buffers, e.g., phosphate buffers, acids, and/or bases. An advantage of using such liquids (e.g., liquids that can be suitable for animal/human consumption) is that the resulting extracts can be added directly to animal muscle products intended for animal/human consumption, whereas extracts made with other liquids, e.g., acetone, or alcohol, may require further processing (e.g., to evaporate a toxic liquid), produce toxic fumes, or damage the muscle protein product (e.g., by destroying proteins).

Muscle tissue can be used substantially intact, e.g., as whole fillets (when using fish), or whole breast (when using chicken). To obtain muscle protein extracts with antioxidative properties, the muscle tissue can optionally be homogenized, e.g., chopped manually using cutlery such as a knife, or ground mechanically using any type of mechanical grinder, before and/or during the extraction process.

When using exogenously-added liquids, a muscle tissue extract can be prepared by simply washing or homogenizing the muscle tissue with the liquid. For example, muscle tissue can be ground, as described above, and homogenized with the liquid. The liquid can then optionally be separated from the muscle tissue. The separation can be performed using any method known in the art for separating particulate matter from liquids, e.g., manually (e.g., by allowing the particulate matter to settle, and decanting the liquid), by filtration (e.g., through cheesecloth or using any commercially available filter or filtration device), and/or by centrifugation (e.g., with low gravitational force, e.g., about 500×g).

Muscle tissue extracts that contain no exogenously-added liquid can be prepared by obtaining liquid that is endogenous to the muscle tissue. Such extracts can be obtained, for example, by “pressing” the muscle tissue. For example, ground muscle can be centrifuged at a relatively high gravitational force, e.g., greater than 10,000×g, 15,000×g, 20,000×g, or 22,000×g, and the resulting supernatant (the muscle protein extract) can be used in accordance with the present invention. As another example, muscle tissue can be pressed using a French press. Such extracts can optionally be filtered, as described above.

Filtered and/or unfiltered extracts described above can be used in the methods of the present invention. Optionally, the extracts can be processed further prior to use. For example, proteins present in the extract can be removed or inactivated. To inactivate proteins, the filtered or unfiltered extracts can be subjected to heating to denature proteins present in the extracts. Such heating may also facilitate filtration of the extracts, described in further detail below. Alternatively or in addition, proteins can be removed by centrifugation (e.g., at greater than about 17,000×g, e.g., greater than about 17,200×g, 17,800, or 18,000×g) and/or filtration (e.g., using filters with pore sizes allowing molecules that are less than about 5,000 Da to pass through the filter).

As another example of further processing, the extracts can be treated to purify the extract components. Extract components can be purified using filtration techniques, e.g., ultrafiltration or microfiltration. Alternatively or in addition, the extracts can be treated to concentrate the extract components. Such concentration can be performed by any method known in the art for removing water from solutions, e.g., reverse osmosis, evaporation, and/or freeze concentration.

Further, extracts can be treated to remove substantially all of the water from the extract, e.g., by drying, to prepare a solid or semi-solid extract. Any method known in the art for drying liquids, e.g., evaporation, e.g., spray drying, and/or using ovens, drying cabinets, or vacuums of any kind, can be employed.

It is contemplated that extracts can be processed further using any one or a combination of the above-described methods. Where a combination of methods is used, the methods can be performed in any appropriate order. For example, to facilitate complete drying of an extract, the extract can be heated (e.g., to denature proteins), concentrated, e.g., by ultrafiltration, and then dried to completion, e.g., by spray drying.

Use of Muscle Tissue Extracts

The extracts can be used to preserve any type of muscle protein, and can be used in any form described above, e.g., liquid, solid (e.g., as a powder), or semi-solid form. The muscle tissue to be protected with the extracts can be any type of animal muscle tissue that is subject to becoming rancid by oxidation, e.g., heme-catalyzed lipid oxidation. Examples include poultry (e.g., chicken or turkey), fish, crustacea (e.g., shrimp or crab), molluscs, beef, pork, and lamb. In the case of ground or minced muscle protein, the extract can be mixed into the muscle protein before or shortly after grinding or mincing. In the case of “intact” muscle, e.g., steaks or fillets, the extracts can be applied directly to surfaces of the intact muscle, e.g., by applying a powder or dipping or submerging the meat in a concentrated solution of the extract.

The appropriate amount of extract to add to muscle tissue is determined by considering several factors, including the type and amount of the muscle tissue from which the extract was obtained. In one embodiment, a determination can be made by considering the weight of the muscle tissue from which the extract was obtained and the weight of the muscle tissue to which the extract is to be added. The extract can be added to muscle tissue to be preserved on the basis of proportion. With liquid extracts, for example, if 1 ml of extract is obtained from 10 lbs of muscle tissue (regardless of the source of the muscle tissue), then 1 ml of the extract can be an appropriate amount to add to 10 lbs of the muscle tissue (regardless of source) to be preserved. As another example, with solid extracts (e.g., powders), if one ounce of solid extract is obtained from 10 lbs of muscle tissue, then one ounce of the solid extract may be an appropriate amount to add to 10 lbs of muscle tissue to be preserved. Extracts can be added to muscle tissue in amounts that range from about 10 fold lower to about 10 fold higher, e.g., about 8 fold lower to about 8 fold higher, about 6 fold lower to about 6 fold higher, about 5 fold lower to about 5 fold higher, about 3 fold lower to about 3 fold higher, about 2 fold lower to about 2 fold higher than a proportion equal to the amount of extract found in the unprocessed, unwashed source of the muscle tissue.

In another embodiment, a determination can be made with reference to the concentration of the extract components in “natural” (e.g., unwashed, unprocessed) muscle tissue. For example, if washed muscle tissue is to be preserved by the methods of the present invention, then extract can be added to bring the concentration of extract components in the washed muscle to “natural” muscle tissue levels (a natural level). Extract can be added to muscle tissue in amounts that bring the concentration of extract components in the muscle to a range of about 10 fold lower to about 10 fold higher, e.g., about 8 fold lower to about 8 fold higher, about 6 fold lower to about 6 fold higher, about 5 fold lower to about 5 fold higher, about 3 fold lower to about 3 fold higher, about 2 fold lower to about 2 fold higher, or 10 fold lower to 3 fold higher, than “natural” levels.

The methods described herein are also particularly well-suited for use with processes for making washed minced muscle products such as edible protein gels, e.g., surimi. Methods of making edible protein gels are described, for example, in U.S. Pat. Nos. 6,136,959; and 6,288,216. Because minced and washed muscle is particularly susceptible to lipid oxidation, muscle protein extracts described herein can be added during the process to inhibit oxidation. Further, in processes for making protein gels, the animal muscle, e.g., fish muscle, is often washed once or several times prior to further processing to create the edible protein gel. It is therefore contemplated that the “wash water” that is produced as a by-product of edible protein gel (e.g., surimi) production can be collected, optionally processed as described herein to concentrate the extract, and added back into the animal muscle. Such “wash water” can also be used as described herein to preserve any other muscle tissue.

The invention will be further described in the following examples, which do not limit the scope of the invention defined by the claims.

### EXAMPLES

### Example 1

### An Aqueous Fraction of Cod Muscle Inhibits Hemoglobin-Mediated Oxidation of Cod Muscle Membrane Lipids

Fish and Chicken

Fresh cod (Gadhus morhua), haddock (Melanogrammus aeglefinus), American dab (Hippoglossoides plattessoides), winter flounder (Pseudopleuronectes americanus) and herring were used. The white muscle from these fish was manually removed and ground using a kitchen grinder (Ultra Power Model: KS M90, Kitchen Aid Inc., St Joseph, Mich.). Live chicken was obtained from Longwood Farm (Reading, Mass.). The bird was sacrificed by carbon dioxide asphyxiation. The skin around the breast muscle was immediately cut open and the breast muscles removed and ground as above. Fresh skin-on chicken breasts were also used, and the skin was removed and the muscle was ground as above.

Washed Cod Muscle Model System

Washed cod was prepared in two different ways to obtain “regular” (about 80% moisture) and “low moisture” (about 70-75% moisture) washed cod. The latter was made to allow large additions of press juice without exceeding physiological moisture contents (about 82%).

For “regular” washed cod, 300 g of ground cod was washed twice with 3 volumes of ice-cold distilled water at the natural pH and once with 50 mM sodium phosphate buffer (pH 6.65). In the first two washes, fish and washing solution was stirred manually for 1 minute and then leached for 15 minutes at 4° C. Muscle was collected via filtering the suspension through glass fiber screen (hole-size=1.7 mm×1.7 mm, Gloucester Building Center, MA). In between the second and third wash, the drained ground muscle was chopped for 2×30 seconds in a stainless steel chopper (Model R 301 Ultra, Robot Coupe USA Inc., Ridgeland, Miss.) after which the buffer was stirred with the muscle for 6 minutes by hand. Following 15 minutes leaching, the washed muscle was collected via centrifugation (20 minutes, 15 000×g, 4° C.) in a Beckman Ultracentrifuge L8-55M (Beckman Instruments Inc., Palo Alto, Calif.) using a 19-type rotor (Beckman Instruments Inc.). The pH of the washed cod (˜6.7) was adjusted to the pH of unwashed cod (7.3) using 50 mM Na₂CO₃ An unwashed control was prepared by subjecting ground unwashed cod to an identical 2×30 seconds chopping as that included in the washing process. Half of this control sample was kept at its original moisture (82%) and half was adjusted to the moisture of the washed cod (90.6%) using ice-cold double distilled water (DDW). Both unwashed and washed cod systems were used immediately.

To prepare “low moisture” washed cod, 600 g of ground cod muscle was washed once with 3 volumes of distilled water at natural pH (˜pH 7) and twice with 3 volumes of 50 mM NaCl at pH 5.5. In the first two washes, fish and washing solution was stirred manually for 1 minute and then leached for 15 minutes at 4° C. Muscle was collected via filtering the muscle suspension through glass fiber screen. In the third wash, the muscle and washing solution was homogenized (1 minute, speed 4) with a Kinematica Gmb H Polytron (Type PT 10/35, PCU 1, Brinkman Instruments, Westbury, N.Y.) and then centrifuged for 20 minutes (15 000×g, 4° C.) as above. The washed cod was packed in plastic bags and was frozen at −80° C. Upon use, the muscle was thawed in the plastic bag under cold running water. Excess water being released was squeezed out using cheese-cloth. The final moisture usually ranged from 70 to 75%.

Preparation of Press Juices

200 g of the ground muscles from cod, haddock, dab sole, winter flounder, herring and chicken were packed in 200 ml polypropylene centrifuge bottles (Beckman Instruments Incorporated, Palo Alto, Calif.) and centrifuged at 22,000×g for 15 hours at 4° C. The press juice obtained was filtered though four layers of cheesecloth and used immediately or after short term frozen storage at −80° C.

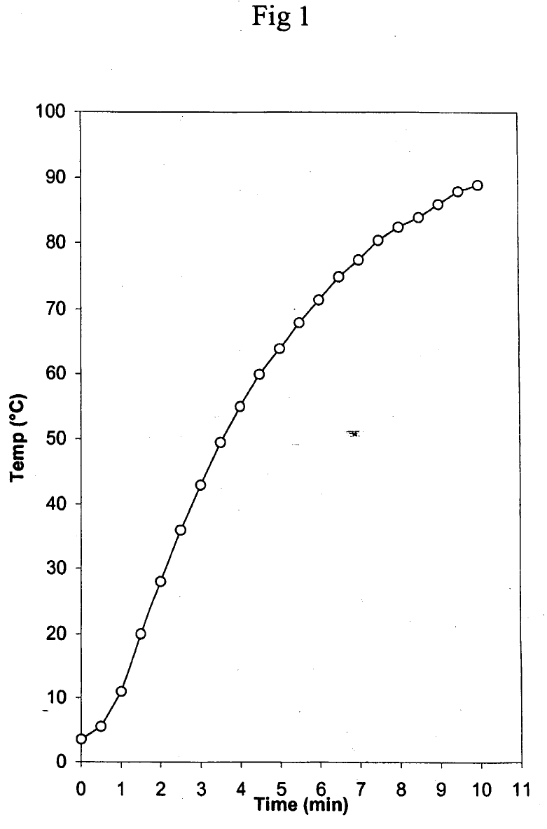

Twenty milliliters of each press juice was poured into 70 ml polycarbonate centrifuge bottles (Beckman Instruments Incorporated, Palo Alto, Calif.) and held in a boiling water bath for 10 minutes. The temperature increase in the press juice during this heat treatment is shown in FIG. 1. After 30 minutes of cooling on ice, the coagulated press juices were centrifuged at 17,800×g (20 minutes, 4° C.). The supernatants were then filtered through a #1 Whatman filter (Whatman International, Maidstone, UK) and the filtrate was frozen at −80° C.

Using a stirred 50 ml Amicon ultra filtration cell (Model 52, Amicon Corporation, Danvers, Mass.), 50 ml of either crude or heated cod muscle press juice was filtered through a 1 kDa ultrafiltration membrane (Millipore Corporation, Bedford, Mass.) at 50 psi. For the crude press juice, a 30 kDa ultrafiltration membrane (Millipore Corporation, Bedford, Mass.) was also used. The first 25 ml of filtrate were collected and frozen at −80° C.

Ten ml of the crude cod press juice, heated cod press juice and <30 kDa fraction of crude cod press juice was each dialyzed against 4000 mL of 50 mM phosphate buffer (pH 7) at 4° C. for 48 hours. The buffer was changed once during this period. The cut-off molecular weight (MW) of the dialysis tubing was 3.5 kDa (Fisher Scientific, Fair Lawn, N.J.). The dialysis retentates were frozen at −80° C.

Bleeding of Fish, Preparation of Hemolysate and Analysis of Hemoglobin (Hb)

Trout were bled as described by Rowley et al. (A. F. Collection, separation and identification of fish leukocytes. In Techniques in Fish Immunology; J. S. Stolen et al., Eds.; SOS Publications: N.J., 1990; pp 113-135). Hemolysate was prepared from the whole blood using the method of Fyhn et al., Comp. Biochem. Physiol. 1979, 62A, 39-66). To quantify the Hb levels in the hemolysate and press juices, the method of Brown (J. Biol. Chem. 1961, 236, 2238-2240) was adapted as described by Richards and Hultin (J. Agric. Food Chem. 2000, 48, 3141-3147).

Preparation of Oxidation System

To compare washed and unwashed ground cod under identical conditions of muscle fiber size, moisture and pH, 25 g of ground and chopped unwashed cod (with or without adjustment of moisture to 90.6%) as well as 25 g “regular” washed cod were mixed with 200 ppm streptomycin sulfate (Sigma, St Louis, Mo.). The mixing was done by hand (2 minutes, ˜160 turns/min) in a 250 ml plastic beaker (bottom diam. 60 mm) using a stainless steel spatula. The pH of the samples was controlled and, if needed, adjusted to 7.3 using 2N NaOH (Fisher Scientific, Fair Lawn, N.J.). Trout hemolysate giving a final concentration of 6 μM Hb, or a corresponding amount of water, was then stirred in by hand (2 minutes). The samples were flattened out with an L-shaped stainless steel spatula in the bottom of 125 ml screw capped Erlenmeyer flasks (Pyrex, bottom diameter 60 mm, Fisher Scientific, Fair Lawn, N.J.).

In the following experiments, 5-15 g portions of the thawed and dewatered “low moisture” washed cod model system was mixed by hand (2 minutes) with 200 ppm streptomycin sulfate and enough press juice to bring the moisture of the model system to ˜82%. Typically, 5 g of a washed cod with ˜70% moisture was fortified with 3.4 mL press juice or 15 g of washed cod system with ˜75% moisture was fortified with 6 mL press juice. Trout hemolysate was then stirred in by hand (2 minutes) to a final concentration of 6 μM Hb. In control samples, the press juice was replaced by the same amount of either 50 mM sodium phosphate buffer (pH 6.6) or double distilled water (DDW). The pH of the samples was adjusted to 6.6±0.1. Small samples (5 g cod+3.4 mL press juice) were then flattened out in the bottom of 30 ml brown, screw capped glass bottles (bottom diam. 34 mm, Wheaton, Millville, N.J.). Large samples (15 g cod+6 mL press juice) were flattened out in the bottom of 225 ml screw-capped Erlenmeyer flasks (Bottom diameter 75 mm). Samples were stored on ice until bacterial growth became sensorically evident, typically after 7-10 days.

Tentative effector compounds in the press juice were evaluated for their antioxidative capacity. All compounds were dissolved/diluted in DDW and then added to the “low moisture” washed cod to bring the moisture up to 82%. The tested compounds and their final concentrations in the aqueous phase of the model system included: potassium dihydrogen phosphate (Pi) (0.2 and 40 mM) (ACS certified, Fisher Scientific, Fair Lawn, N.J.), sodium tripolyphosphate (STPP) (0.2%) (pentasodium salt, 90-95%, practical grade, Sigma, St Louis), pyrophosphate (15 μM) (anhydrous sodium salt, Sigma, St Louis), 2,3, diphopsphoglycerate (5.8 and 58 μM) (Sigma, St. Louis, Mo.), calcium chloride (70 mM) (Baker analyzed reagent, JT Baker, Phillipsburg, N.J.), trimethylamine oxide (TMAO) (100 μM and 1 mM) (Sigma, St. Louis, Mo., USA) as well as spermine (10 μg and 100 μg per gram model system (Sigma, St. Louis, Mo.).

Analysis of Moisture Content, pH and Total Proteins

The moisture content of whole and washed cod was measured using a Cenco™ infrared moisture balance (CSC Scientific Co., Inc.) or by heating the samples at 105° C. overnight. The pH was recorded with an Orion combination epoxy Ross® Sure-Flow™ Electrode (Orion Research Inc, Beverly, Mass.) in conjunction with a pH-meter (Orion Research Inc., Boston, Mass.). In muscle samples, the pH was measured after manually stirring one part muscle with 9 parts DDW. Total proteins were measured according to Lowry et al. (J. Biol. Chem. 1951, 193, 265-275) as modified by Markwell et al. (Analytical Biochem. 1978, 87, 206-210).

Electrophoresis

Proteins in the whole and fractionated press juices were separated according to the electrophoresis procedure described by Laemelli (Nature. 1970, 227, 680-685) using pre-cast mini linear gels 10-20% (ICN Biomedicals Inc., Aurora, Ohio) on a vertical PAGE Mini Device (Daiichi Scientific, Tokyo, Japan) with a constant current of 30 mA per gel. The protein samples were diluted twice in a pre-made sample buffer (Sigma, St. Louis, Mo.) and heated 1 minute at 100° C. Protein bands were fixed using a 1 hour incubation in 12% trichloroacetic acid, followed by overnight staining using Pro-Blue (Owl Separation Systems, Portsmouth, N.H.). Scanning of the stained gels was accomplished using a Hoefer Scanning Densitometer (Model GS 300, Hoefer Sci., San Fransisco, Calif.) in the transmittance mode with Model 365W Densitometer Analysis software for protein quantification. A standard curve was constructed using wide range molecular weight SDS-PAGE standards (Sigma, St. Louis, Mo.) on a linear gradient as described by Hames (1981).

Sensory Analysis

Three to four trained panelists (see, e.g., Richards et al., J. Agric. Food Chem. 1998, 46, 4363-4371) sniffed samples in 30 mL screw-capped glass bottles or 225 mL screw-capped Erlenmeyer flasks. Panelists concentrated on detecting stale, fishy and painty odors using a scale of 0 to 10, with 10 being the strongest. Reference samples were prepared according to Richards et al. (Id). The lag phase for development of the different odors is defined as time elapsing until an intensity of 1 is reached.

Peroxide Value (PV) Analyses

At regular intervals during storage, one 0.5-0.8 g sample “plug” were taken out from each sample for PV analyses. The plugs were removed using a plastic cylinder (diam. 1 cm) and thus, had constant surface to volume ratio. The samples were stored in aluminum foil at −80° C. until the day of analysis. PV was determined with a modified version of the ferric thiocyanate method (Santha et al., J. AOAC Int. 1994, 77, 421-424). Total lipids were extracted from the muscle with 9 ml chloroform:methanol (1:1) (HPLC grade, Fisher Scientific, Fair Lawn, N.J.). Sample and solvents were homogenized with a biohomogenizer mixer (ESGE, M133/1281-0, Biospec Products Inc., Bartlesville, Okla.). Sodium chloride 2.46 ml (0.5%) (ACS Certified Fisher Scientific, Fair Lawn, N.J.) was added and the sample was vortexed for 30 seconds. Phase separation was achieved after 10 minutes centrifugation at 2000×g in a table-top centrifuge (IEC Clinical Centrifuge equipped with a 809 fixed angle 45° Rotor, International Equipment Co., Needham, Mass.). Two ml of the lower chloroform layer was removed using a 5-ml glass syringe (Model 5016, Popper and Sons Inc., New Hyde Park, N.Y.) equipped with a 20G x 6″ stainless steel needle (Popper and Sons Inc., New Hyde Park, N.Y., USA) and diluted with 1.33 mL chloroform:methanol (1:1). Ammonium thiocyanate (4.38 M) and iron (II) chloride (9 MM) (both from Sigma, St. Louis, Mo.) (33.4 ml of each) were added with 2-4 seconds vortexing between each addition. The sample was incubated for 20 minutes at room temperature and the absorbance was read at 500 nm. A standard curve was prepared using cumene hydroperoxide (80%, Sigma, St. Louis, Mo.). PV is expressed as μmol lipid hydroperoxide/kg of sample. Blanks were prepared according to the described procedure by replacing the 0.5-0.8 g muscle by 0.6 ml ice-cold distilled water.

Trout Hb Deoxygenation and Autoxidation

An aqueous test system consisting of 2 mL phosphate buffer (50 mM, pH 6.6), 1 mL press juice, 200 ppm streptomycin and trout Hb to a final concentration of 6 μM was prepared to mimic the washed cod model system. The final pH of the test system was adjusted to 6.6. Control samples were prepared at pH 6.0 and pH 6.6 by replacing the press juice with phosphate buffer. For each sample, a Hb-free reference sample was prepared. The samples with their corresponding references were stored on ice in 15 mL glass test tubes for up to 12 days. Every day, the samples were scanned between 600 and 500 nm against the Hb-free reference sample. Deoxygenation of trout Hb was measured as the absorbance difference between the peak at 575 nm and the valley at 560 nm. Hb-autoxidation was measured as changes in the absorbance peak at 575 nm using the following formula: −ln (A₅₇₅(stored sample)/A₅₇₅(unstored sample)) (Shikama et al., Chem. Rev. 1998, 98:1357-1373.). Linear regression models (y=kx+m) were calculated to describe how Hb-deoxygenation and Hb-autoxidation (y) were related to storage time (x). To estimate if the presence of press juice affected Hb-deoxygenation and/or Hb-autoxidation, the rate of change (k) for samples with press juice were related to the k-values for the control sample (pH 6.6). For Hb-deoxygenation data, the sample to control ratio was also calculated for the model intercepts (m), i.e., the O-time levels of deoxy-Hb.

Statistics

All storage experiments were repeated at least twice, with PV analyses supporting the sensory analyses during one of these experiments. PV analyses were repeated twice on the lipid extract obtained from each sample. Mean values and standard deviations (SD) were calculated using Excel 2000 (Microsoft Corporation, Seattle, Wash.). In the Hb-deoxygenation and Hb-autoxidation studies, regression analyses were carried out with Excel 2000.

Hemoglobin (Hb)-Mediated Lipid Oxidation in Whole and Washed Minced Cod Muscle

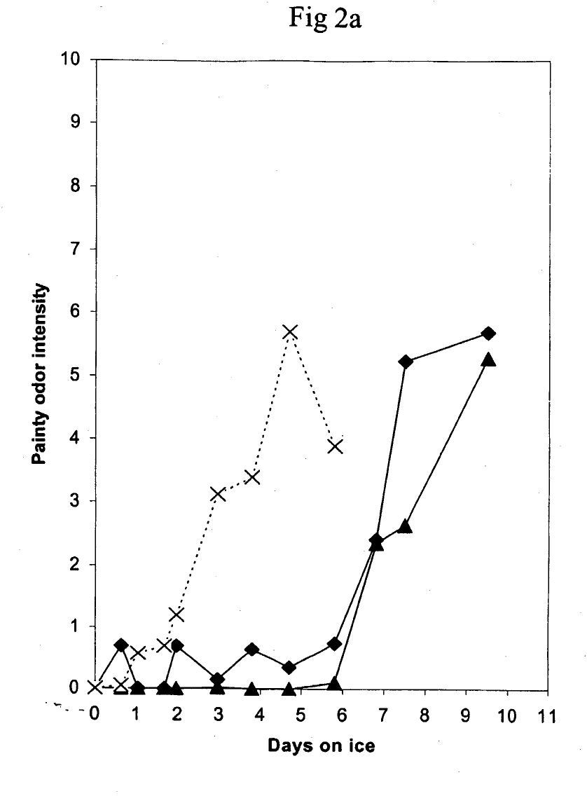

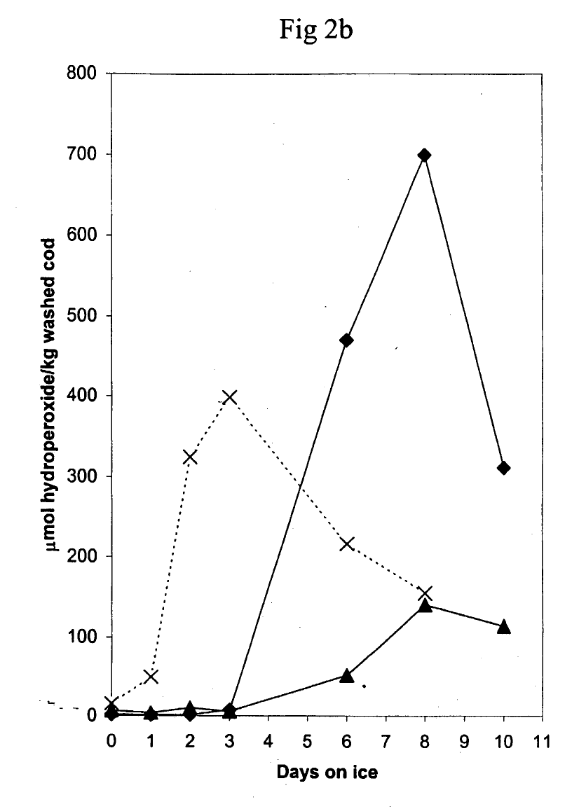

When whole and washed minced cod were stored on ice at the same pH (6.7), moisture content (82%) and Hb-level (6 μM), the lag phase for painty odor development was 6 and 2 days, respectively (FIG. 2A). FIG. 2A shows the storage-induced development of painty odor in whole minced cod muscle (♦), washed minced cod muscle with added cod press juice (▴), and washed minced cod muscle with added double distilled water (DDW; control) (x).

In the washed sample, painty odor started declining at day 5. The peroxide value (PV) was determined in the same samples on which sensory analyses were conducted (FIG. 2B). FIG. 2B shows the storage-induced development of peroxide value (PV) in whole minced cod muscle (♦), washed minced cod muscle with added cod press juice (▴), and washed minced cod muscle with added DDW (control) (x).

PV reflected sensory scores in that PV started developing 3 days faster in washed than whole cod. The PV started declining at day 3 and 8 in the washed and unwashed samples, respectively. At the point of decline, the whole cod had reached 1.8 times higher PV's than the washed cod, possibly due to the presence of catalytic systems other than Hb or to more stable lipid hydroperoxides.

Whole and washed minced cod were also compared after adjusting the muscle particle size and moisture content of the whole cod to that of “regular” washed cod. Thus, both samples had been subjected to chopping and contained 91% moisture. The samples were compared at the pH of whole cod (7.3) and at 6 μM Hb. Once again, the paintiness lag phase was 4 days shorter for washed than whole cod (see Table 1, below). Without raising the moisture content (Ma) of the whole cod (82%) to that of the washed cod (91%), which included a 2.2-fold dilution of the endogenous aqueous fraction of the cod muscle, no oxidation developed during 11 days on ice. The same was true when no Hb was added to the whole and washed cod.

TABLE 1
Hemoglobin (Hb)-mediated^{a} development of painty odor^{b}
in unwashed and washed minced and chopped cod^{c}.

| | Painty odor |
|---|---|
| Sample | lag phase (days) |
| Unwashed cod (No Hb, Mc = 90.6%) | ≧11 |
| Unwashed cod (6 μM Hb, Mc = 90.6%) | 8 |
| Unwashed cod (6 μM Hb, Mc = 82%) | ≧11 |
| Washed cod (No Hb, Mc = 90.6%) | ≧11 |
| Washed cod (6 μM Hb, Mc = 90.6%) | 4 |

^{a}Hemoglobin (6 μM) was added as trout hemolysate prepared from whole trout blood using the method of Fyhn et al. (1979).
^{b}The lag phase for development of painty odor was defined as time elapsing until an intensity of 1 was reached.
^{c}Minced cod was washed twice with distilled water (1:3) and once with 50 mM phosphate buffer (pH 6.7) (1:3). In between wash no 2 and 3, the cod was chopped in a stainless steel chopper. The unwashed minced cod was subjected to a similar chopping, after which half of the batch was adjusted to the same moisture as washed cod (91%). All samples were adjusted to a final pH of 7.3.

Hb-mediated Lipid Oxidation After Adding Crude, Heated nad Fractionated Cod Press Juice to Washed Minced Cod Muscle

Minced cod was subjected to centrifugation (22,000×g, 15 hours, 4° C.), and approximately 32% (w/w) of the total aqueous fraction (here referred to as press juice) could be recovered. The protein content in the press juice isolated this way was approximately 51 mg per mL (Table 2, below). After adding cod press juice to washed cod, Hb-mediated oxidation was delayed. At a 3.2-fold dilution level, the same paintiness and PV lag phases developed as were seen in whole cod, 6 and 3 days, respectively (FIGS. 2A and 2B). In both whole cod and washed cod fortified with press juice, the PV started declining at day 8. However, in the washed sample with press juice, the maximum PV was only about 20% of that in whole cod.

TABLE 2
Total protein concentration and concentration of low molecular weight
(˜8 kDa) polypeptides in different fractions of cod press juice.

| | Total Protein | Polypeptides |
|---|---|---|
| Sample | (mg/mL) | ˜8 kDa (mg/mL)^{a} |
| Unheated press juice^{b} | 51 | 6.1 |
| Heated press juice^{c} | 3.7 | 3.2 |
| >3.5 kDa fraction of press juice^{d} | 42 | 3.2 |
| >3.5 kDa fraction of heated press juice^{d} | 2.6 | 2.3 |
| <1 kDa fraction of press juice^{e} | 0.25 | nd |
| <1 kDa fraction of heated press juice^{e} | 0.24 | nd |
| <30 kDa fraction of press juice^{e} | 0.40 | 0.20 |
| <30, >3.5 kDa fraction of press juice^{d,e} | 0.17 | 0.13 |

^{a}Quantification of 8 kDa polypeptides was done with SDS-PAGE analysis followed by densitometer scanning of the stained gels. nd = non detectable.
^{b}Minced cod muscle was subjected to centrifugation (22 000*g, 15 hours, 4° C.). The press juice obtained was filtered though four layers of cheesecloth and then frozen at −80° C.
^{c}20 ml press juice was held in a boiling water bath for 10 min. After 30 minutes cooling on ice, the coagulated press juices was centrifuged at 17 800*g (20 minutes, 4° C.). The supernatants were filtered through a #1 Whatman filter and the filtrate was frozen at −80° C.
^{d}Ten mL crude, heated or ultrafiltered press juice was dialyzed against 2 × 2 L 50 mM phosphate buffer (pH 7) for 48 hours using dialysis tubing with a 3.5 kDa Mw cut off. The dilalysis retentate was frozen at −80° C.
^{e}Fifty mL crude or heated press juice was subjected to ultrafiltration using a stirred 50 ml Amicon ultra filtration cell equipped with 1 kDa or 30 kDa membranes. The first 25 ml of filtrate were collected and frozen at −80° C.

The degree of diluting the cod press juice was reflected in the length of the paintiness lag phase obtained in the washed cod (see Table 3, below). At 2, 3.2, and 6-fold dilution levels, the average lag phases were ≧8 days (n=4), 6.7±1.8 days (n=4) and 4.1±1.3, days (n=2) respectively. In control samples, where the endogenous aqueous phase had been diluted ˜70 times, the average lag phase was 1.8±0.2 days (n=11).

TABLE 3
Effect from cod press juice^{a} on Hb-mediated^{b} development of
painty odor in washed cod^{d} after different degrees of dilution^{e}.

| | Painty odor |
|---|---|
| Sample | lag phase (days) |
| Cod press juice (dilution = 2) | ≧8 |
| Cod press juice (dilution = 3.2) | 6.7 ± 1.8 |
| Cod press juice (dilution = 6) | 4.1 ± 1.3 |
| Control (DDW) (dilution = 70) | 1.8 ± 0.2 |

^{a}For press juice preparation, see Table 2.
^{b}For trout hemolysate preparation, see Table 1. Final Hb-level was 6 μmol/kg washed cod.
^{c}For lag phase definition, see Table 1.
^{d}Minced cod was washed once with distilled water (1:3) at pH 7 and twice with 50 mM NaCl (1:3) at pH 5.5. In the last wash, muscle and 50 mM NaCl was homogenized followed by centrifugation (15 000*g, 20 minutes, 4° C.). The washed muscle was then frozen at −80° C. When thawed, excess water was manually squeezed out to reduce the moisture content down to 70-75%.
^{e}The 2 and 3.2 fold dilutions were obtained when using cod press juice to raise the moisture content of the “extra dry” model system from 70% and 75%, respectively, to 82%. For the 6-fold dilution, the added press juice was first diluted with distilled water. Experiments were repeated 4, 4, 2 and 11 times at the 2, 3.2, 6 and 70-fold dilution levels, respectively. The final pH in the samples ranged between 6.55-6.7.

When increasing the Hb-concentration of the washed cod from 6 to 10 μM, the development of painty odor was still completely prevented in the presence of cod press juice at a 2-fold dilution level (data not shown). In controls, without press juice added, the paintiness lag phase did not change, but the intensity became 1.7 higher at 10 compared to 6 μM Hb.

Table 4, below, illustrates that when decreasing the pH of the washed cod model system from pH 6.6 to 6.0, the lag phase for Hb-mediated paintiness development decreased from ˜1.5 to ˜0.7 days. In the presence of cod press juice diluted 3.2 times, the lag phases at pH 6.0 and 6.6 became 2.7 and 6.5 days, respectively. Thus, the presence of cod press juice extended the lag phase by 2 days at pH 6.0 and by 5 days at pH 6.6. At both pH-values, the relative extension of the lag phase caused by adding press juice was about 4-fold.

TABLE 4
Effect from pH on Hb-mediated^{a} development of painty odor^{b}
in washed cod^{c} with or without added cod press juice^{d}.

| | Painty odor |
|---|---|
| Sample | lag phase (days) |
| Control (DDW) pH 6.0 | 0.7 |
| Control (DDW) pH 6.6 | 1.5 |
| Cod press juice pH 6.0 | 2.7 |
| Cod press juice pH 6.6 | 6.5 |

^{a}For trout hemolysate preparation, see Table 1. Final Hb-level was 6 μmol/kg washed cod.
^{b}For lag phase definition, see Table 1.
^{c}Washed cod was prepared as described in Table 3.
^{d}Press juices were prepared as described in Table 2 and added at a 3.2-fold dilution level. In the control samples, press juice was replaced by double distilled water (DDW).

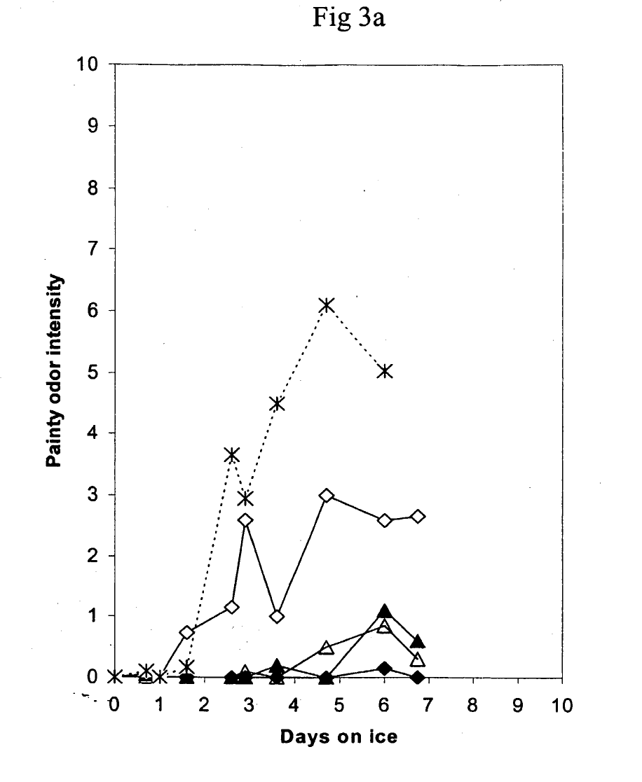

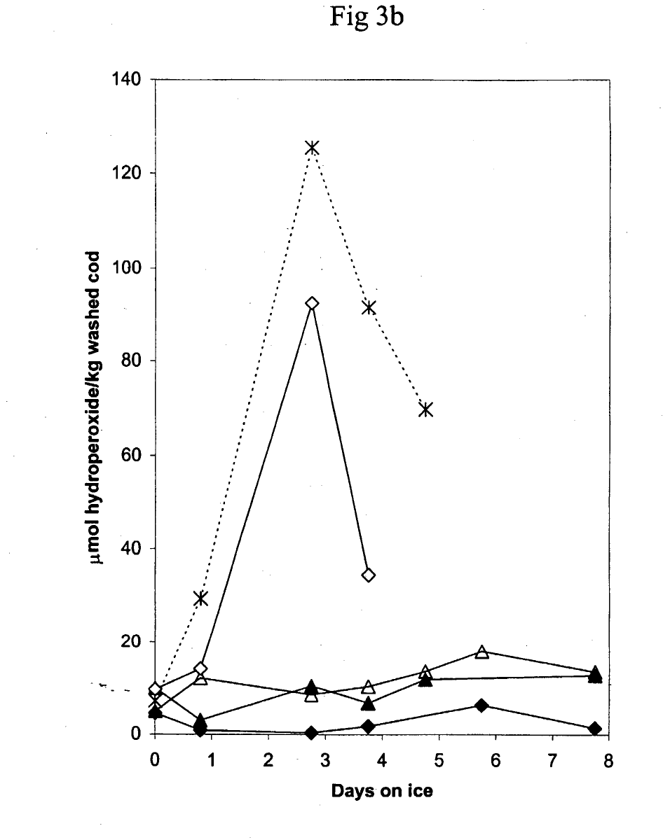

As shown both by odor and PV analyses, the antioxidative properties of the cod press juice were unchanged after 10 minutes heating in a 100° C. water bath followed by centrifugation (17,800×g, 20 minutes, 4° C.) to remove coagulated proteins (FIGS. 3A and 3B). This was the case both at a 3.2-fold (shown) and a 2-fold dilution (data not shown).

FIG. 3A shows the storage-induced development of painty odor in washed minced cod muscle with added 50 mM phosphate buffer (control) (*), crude cod press juice (▴), heated cod press juice (Δ), crude chicken press juice (♦), and heated chicken press juice (⋄). FIG. 3B shows the storage-induced development of PV in washed minced cod muscle with added 50 mM phosphate buffer (control) (*), crude cod press juice (▴), heated cod press juice (Δ), crude chicken press juice (♦), and heated chicken press juice (⋄).

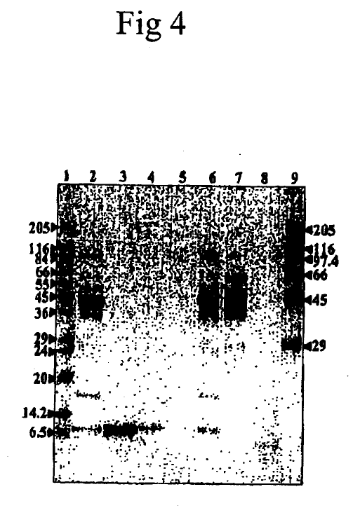

After heating, polypeptide band(s) remained at approximately 8 kDa (FIG. 4, lane 3) and was about 50% of what was initially present in the 8 kDa-region (see Table 2, above). FIG. 4 is a polyacrylamide gel (SDS-PAGE) (10-20%, linear gradient) that shows the sizes of the proteins in cod press juice before/after heating and fractionation. Lane 1: wide range molecular weight standards; Lane 2: cod press juice; Lane 3: heated cod press juice; Lane 4: <30 kDa fraction of cod press juice; Lane 5, <1 kDa fraction of cod press juice; Lane 6: cod press juice dialysis retentate; Lane 7: chicken press juice; Lane 8: heated chicken press juice; and Lane 9: high molecular weight standards. Protein was applied to all lanes at 7 μg/lane.

Without using other techniques, it is not possible to conclude whether these were the same polypeptides present in the unheated samples. It is possible that the original polypeptide was precipitated, and polypeptides of a similar range were produced during the heating process. The total protein content in heated press juice was about 7% of that in unheated press juice (see Table 2, above). Chicken press juice lost its antioxidative properties following heating at 100° C. (FIGS. 3A and 3B). Heated chicken press juice was almost devoid of polypeptide bands in the 8 kDa-region (FIG. 4, lane 8). However, compared to press juices from fish, the initial level of 8 kDa-polypeptides in unheated chicken press juice was also relatively low (see Table 2, above).

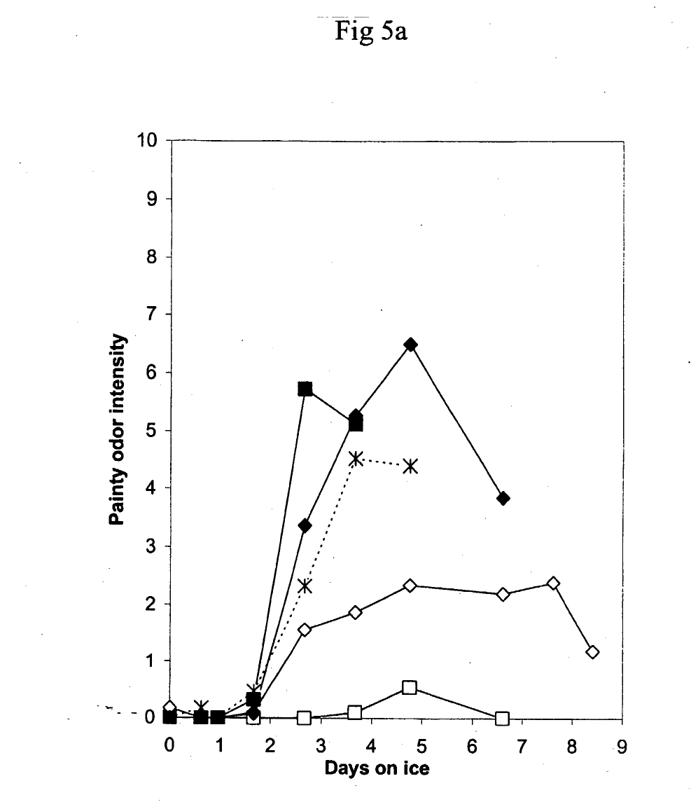

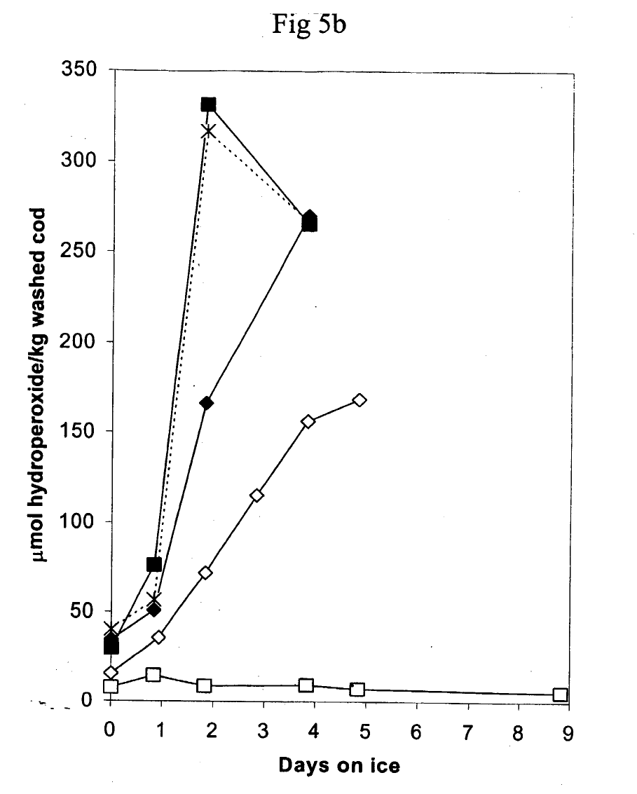

The antioxidative properties of unheated and heat-treated cod press juice were lost when the <3.5 kDa fraction was removed by dialysis (48 hours, 4° C.) (FIGS. 5A and 5B).

FIG. 5A shows the storage-induced development of painty odor in washed minced cod muscle with added 50 mM phosphate buffer (control) (*), crude cod press juice stored 48 hours at 4° C. (□), crude cod press juice dialyzed for 48 hours against 50 mM phosphate buffer (pH 7) (3.5 kDa MW-cut off) (▪), heated cod press juice stored 48 hours at 4° C. (⋄), and heated cod press juice dialyzed for 48 hours against 50 mM phosphate buffer (pH 7) (3.5 kDa MW-cut off) (♦).

On the other hand, FIG. 5B shows the storage-induced development of PV in washed minced cod muscle with added 50 mM phosphate buffer (control) (*), crude cod press juice stored 48 hours at 4° C. (□), crude cod press juice dialyzed for 48 hours against 50 mM phosphate buffer (pH 7) (3.5 kDa Mw-cut off) (▪), heated cod press juice stored 48 hours at 4° C. (⋄), and heated cod press juice dialyzed for 48 hours against 50 mM phosphate buffer (pH 7) (3.5 kDa Mw-cut off) (♦).

Control samples of unheated and heat-treated cod press juice were also stored at 4° C. for 48 hours before adding them to washed cod. This storage period did not in itself affect the inhibitory properties of crude cod press juice, but rendered the heated press juice less inhibitory (FIGS. 3A, 3B, 5A, and 5B).

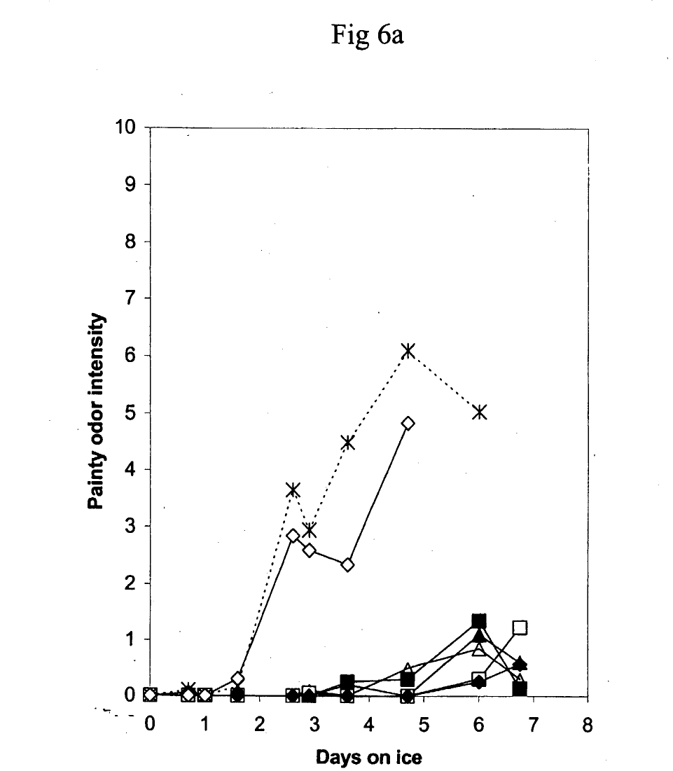

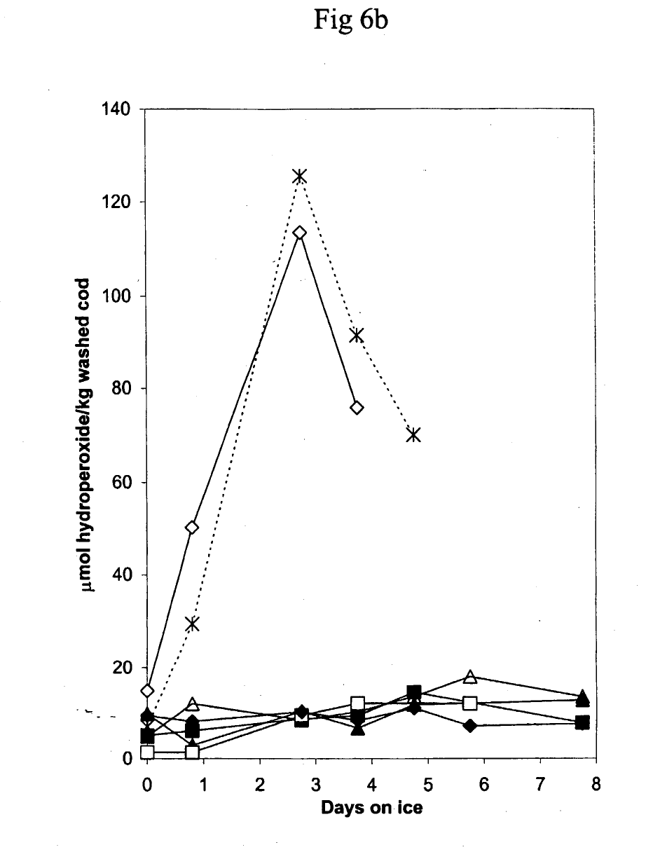

Unheated and heated cod press juices were subjected to ultrafiltration (1 and 30 kDa membranes) after which the filtrates were tested for their ability to inhibit Hb-mediated oxidation at 3.2-fold dilution. All antioxidative capacities of unheated and heated press juices remained in the <1 kDa fractions (FIGS. 6A and 6B). FIG. 6A shows the storage-induced development of painty odor in washed minced cod muscle with added 50 mM phosphate buffer (control) (*), crude cod press juice (▴), <1 kDa fraction of cod press juice (▪), <30 kDa fraction of cod press juice (♦), <30 kDa fraction of dialyzed cod press juice (⋄), heated cod press juice (Δ) and <1 kDa fraction of heated cod press juice (□).

FIG. 6B shows the storage-induced development of PV in washed minced cod muscle with added 50 mM phosphate buffer (control) (*), crude cod press juice (▴), <1 kDa fraction of cod press juice (▪), <30 kDa fraction of cod press juice (♦), <30 kDa fraction of dialyzed cod press juice (⋄), heated cod press juice (Δ), and <1 kDa fraction of heated cod press juice (□).

The <30 kDa fraction of unheated cod press juice showed the same inhibitory properties as did the <1 kDa fraction. However, after dialyzing the <30 kDa fraction, the inhibitory properties were lost (FIGS. 6A and 6B). The 48 hours storage period at 4° C. did not affect the antioxidative properties of the <30 kDa fraction. The <30 kDa, 3.5-30 kDa and <1 kDa fractions of cod press juice all contained <1% of the initial proteins in the cod press juice (see Table 2, above). However, the polypeptides in the <1 kDa fraction were too small to be retained on the 10-20% cross linked electrophoresis gels (FIG. 4, lane 5).

Hb-Mediated Lipid Oxidation after Adding Crude and Heated Press Juice from Additional Fish Species and from Chicken to Washed Minced Cod Muscle.

Table 5, below, illustrates the ability of heated press juices from cod, haddock, dab, winter flounder, herring and chicken to prevent Hb-mediated paintiness development in washed cod at 2-fold dilutions. Heated press juices from all the white fish species inhibited oxidation to the same extent as did heated cod press juice (>7 day lag phases). Heated herring and chicken press juices did not extend the paintiness lag phase as compared to the control (Table 5), but reduced the maximum paintiness intensity by about 50% (FIG. 4, lanes 2 and 8).

TABLE 5
Hb-mediated^{a} development of painty odor^{b} in washed cod^{c}
after adding heated press juices^{d} from fish and chicken

| | Painty odor |
|---|---|
| Sample | lag phase (days) |
| Control (DDW) | 1.5 |
| Cod | ≧7 |
| Haddock | ≧7 |
| Dab sole | ≧7 |
| Black back | ≧7 |
| Herring | 2 |
| Chicken | 2 |

^{a}For trout hemolysate preparation, see Table 1. Final Hb-level was 6 μmol/kg washed cod.
^{b}For lag phase definition, see Table 1.
^{c}Washed cod was prepared as described in Table 3.
^{d}Press juices were prepared and heated as described in Table 2.
Press juices were added at a 2-fold dilution level. In control samples, the press juice was replaced by DDW. The final pH in the samples ranged between 6.5-6.65.

Table 6, below, illustrates the protein concentrations in the different heated press juices ranged from 2.5-7.6 mg/mL, which was the result of removing 88-97% of the proteins in the heating-centrifugation procedure. For fish, but not for chicken, the majority (49-93)% of the heat-resistant proteins/peptides were located in the 8 kDa-region (FIG. 4, lanes 3 and 8).

TABLE 6
Total protein concentration and concentration of low molecular
weight (˜8 kDa) polypeptides^{a} in unheated and heated press
juices^{b} from different fish species and chicken.

| | Total Protein | Polypeptides |
|---|---|---|
| Press juice | (mg/mL) | ˜8 kDa (mg/mL) |
| Cod | 51 | 6.1 |
| Heated cod | 3.7 | 3.2 |
| Dab | 73 | 11.8 |
| Heated dab | 7.6 | 5.8 |
| Haddock | 85 | 9.5 |
| Heated haddock | 2.5 | 2.3 |
| Winter flounder | 66 | 4.7 |
| Heated winter flounder | 7.9 | 4.8 |
| Herring | 99.3 | 7.2 |
| Heated herring | 7.6 | 6.7 |
| Chicken | 150 | 3 |
| Boiled chicken | 7 | 0.22 |

^{a}Press juices were prepared and heated as described in Table 2.
^{b}Quantification of 8 kDa peptides was done as described in Table 2.

Evaluation of Antioxidative Mechanism and Tentative Antioxidative Candidates

Table 7, below, illustrates that deoxygenation and/or autoxidation of trout Hb is affected in the presence of fractionated cod press juice. The comparison was made after regression analysis of the data. In Table 7, 0-time data (intercepts, m) and rate coefficients (k) data describing changes over time are given as ratios between samples and a control without added press juice. Increased levels of deoxy-Hb are denoted by intercept ratios <1 and rate coefficient ratios >1: Increased levels of met-Hb are indicated by intercept and rate coefficient ratios >1. The rate of Hb-deoxygenation was slightly enhanced in the presence of heated press juice, the <1 kDa fraction of heated press juice and the <1, <30 and 3.5-30 kDa fractions of unheated press juice. The most rapid increase in Hb-deoxygenation took place in the presence of the dialysis retentate (i.e., the >3.5 kDa fraction). It is possible that the formation of met-Hb and ferryl Hb was confounding the measurements of Hb-deoxygenation changes over time. The O-time level of oxy-Hb was immediately reduced by about 40% and 50% when the pH of the control sample was reduced to 6.0, and in the presence of the >3.5 kDa fraction, respectively. Hb-autoxidation was slightly accelerated by the <30 kDa fraction and greatly accelerated by the >3.5 kDa fraction as well as by pH-reduction. The other press juice fractions tested did not affect Hb-autoxidation (As seen by the low ratio between the sample and control intercepts (−4) and the high ratio between sample and control rate coefficients (1.9), both the initial level of met-Hb and rate of autoxidation change were increased by reducing the pH of the control from 6.6 to 6.0).

TABLE 7
Effect of fractionated cod press juices^{a} on deoxygenation and autoxidation^{b} of trout Hb^{c}

| | Hb-deoxygenation | | | Hb-autoxidation | | |
|---|---|---|---|---|---|---|
| | Fitness of | m(sample) | k(sample) | Fitness of | m(sample) | k(sample) |
| Sample | model (R2) | m(control) | k(control) | model (R2) | m(control) | k(control) |
| Control (pH 6.6) | 0.93 | 1 | 1 | 1 | 1 | 1 |
| Control (pH 6.0) | 0.92 | 0.6 | 1.3 | 0.9 | −4 | 1.9 |
| Heated press juice | 0.91 | 1.1 | 1.4 | 0.99 | 1.4 | 1 |
| Press juice, <1 kDa | 0.95 | 1.1 | 1.9 | 0.98 | 2.1 | 1.2 |
| fraction | | | | | | |
| Heated | 0.93 | 1.1 | 2.2 | 0.99 | 1.6 | 1.1 |
| press juice, <1 kDa | | | | | | |
| fraction | | | | | | |
| Press juice, <30 | 0.98 | 1.1 | 2.4 | 1* | −1.8 | 1.6 |
| kDa fraction | | | | | | |
| Press juice, 3.5-30 | 0.91 | 1.1 | 1.5 | 0.96 | 2 | 0.8 |
| kDa fraction | | | | | | |
| Press juice, >3.5 | 0.93** | 0.5 | 4.6 | 0.9 | −29 | 12.6 |
| kDa fraction | | | | | | |
| ^{a}press juices were prepared, heated and fractionated as described in Table 2. | | | | | | |
| ^{b}The test system consisted of 2 mL phosphate buffer (50 mM, pH 6.6), 1 mL press juice, 200 ppm streptomycin and 6 μM trout Hb (final pH 6.6). Control samples were prepared at pH 6.0 and pH 6.6 by replacing the press juice with phosphate buffer. For each sample, a Hb-free reference sample was prepared. Samples and references were stored on ice in 15 mL glass test tubes. The samples were scanned daily between 600 and 500 nm against the Hb-free reference. Hb-deoxygenation was | | | | | | |
| # measured as A575 nm-A560 nm. Hb-autoxidation was measured as changes in A575 nm. Linear regression models (y = kx + m) were calculated to describe how Hb-deoxygenation and Hb-autoxidation (y) were related to storage time (x). The regression model intercept (m) and the rate of change (k) for samples with press juice were related to the m and k-values for the control sample (pH 6.6). | | | | | | |

Models marked with * and ** are based on results from 0-9 and 0-3 days of storage, respectively. The other models cover the period 0-12 days.

Tentative low molecular weight (LMW) antioxidant candidates were added to washed cod to test if they could inhibit Hb-catalyzed paintiness development to the same extent as the cod press juice. Physiological levels of inorganic phosphate (40 mM), chloride (70 mM), 2,3-diphosphoglycerate (2,3-DPG) (5.8 μM), trimethyl amine oxide (TMAO) (100 mM) and spermine (1 mg/100 g muscle or 61.2 μM) did not inhibit Hb-catalyzed lipid oxidation as compared to control samples with DDW or phosphate buffer. The same was true for 200 μM potassium phosphate, 15 μM pyrophosphate, 0.2% sodium tripolyphopsphate (STPP), and 58 μM 2,3-DPG (5.8 μM). A slight lag phase extension (from 2 to 3.5 days) was obtained in the presence of 61.2 μM spermine.

### Other Embodiments

A number of embodiments of the invention have been described. Nevertheless, it will be understood that various modifications may be made without departing from the spirit and scope of the invention. Accordingly, other embodiments are within the scope of the following claims.

What is claimed is:

1. A method for preserving muscle tissue, the method comprising:
(a) obtaining a muscle tissue extract containing one or more components, each of which are heat stable at over 80° C. and have a weight of less than 5,000 daltons; and
(b) adding the muscle tissue extract to a muscle tissue in an amount sufficient to prevent hemoglobin-catalyzed lipid oxidation in the muscle tissue, thereby preserving the muscle tissue.

2. The method of claim 1, wherein the muscle tissue extract is obtained by washing animal muscle with an aqueous solution and collecting the aqueous solution after washing.

3. The method of claim 2, wherein the animal muscle is selected from the group consisting of fish, poultry, beef, lamb, and pork muscle.

4. The method of claim 2, wherein the animal muscle comprises white fish muscle.

5. The method of claim 1, wherein the muscle tissue extract is obtained by pressing animal muscle and collecting press juice.

6. The method of claim 5, wherein in the animal muscle is selected from the group consisting of fish, poultry, beef, and pork muscle.

7. The method of claim 5, wherein the animal muscle comprises white fish muscle.

8. The method of claim 1, wherein the muscle tissue extract is obtained by washing animal muscle with an aqueous solution, pressing the animal muscle, and collecting aqueous solution and press juice from the pressing.

9. The method of claim 1, wherein the muscle tissue comprises fish, poultry, beef, or pork.

10. A method for inhibiting lipid oxidation in muscle tissue, the method comprising:
(a) making a muscle tissue extract by a method comprising:
obtaining a first muscle tissue; and
washing the first muscle tissue with an aqueous solution to form a muscle tissue extract, wherein the muscle tissue extract contains a compound that has a weight of less than 5,000 daltons; and
(b) adding the muscle tissue extract to a second muscle tissue, in an amount sufficient to prevent hemoglobin-catalyzed lipid oxidation in the second muscle tissue.

11. The method of claim 10, wherein the first muscle tissue comprises animal muscle from the group consisting of fish, poultry, beef, lamb, and pork muscle.

12. The method of claim 10, wherein the first muscle tissue comprises fish muscle tissue.

13. The method of claim 10, wherein the first and second muscle tissues are from the same type of animal.

14. The method of claim 10, wherein the first muscle tissue comprises fish or krill, and the second muscle tissue comprises fish.

15. A method for inhibiting lipid oxidation in muscle tissue, the method comprising:
(a) making a muscle tissue extract by a method comprising:
obtaining a first muscle tissue; and
pressing the first muscle tissue to obtain a muscle tissue extract, wherein the muscle tissue extract contains a compound that has a weight of less than 5,000 daltons; and
(b) adding the muscle tissue extract to a second muscle tissue, in an amount sufficient to prevent hemoglobin-catalyzed lipid oxidation in the second muscle tissue.

16. The method of claim 15, wherein the first muscle tissue comprises animal muscle fish, poultry, beef, lamb, or pork muscle.

17. The method of claim 15, wherein the first muscle tissue comprises fish muscle tissue.

18. The method of claim 15, wherein the first muscle tissue is pressed using a French press.

19. The method of claim 15, wherein the first muscle tissue is pressed using centrifugation.

20. A muscle tissue extract comprising one or more components that each have or molecular weight of less than 5000 daltons and that are stable up to a temperature of about 100° C., prepared by washing a muscle tissue with a liquid and collecting the liquid, or by pressing the muscle tissue and collecting any press juices.

21. The extract of claim 20, wherein the liquid or press juice is processed to form a solid.

22. The extract of claim 21, wherein the solid is a powder.
